(19) United States
(12) Patent Application Publication
(10) Pub. No.: US 2004/0030581 A1
(43) Pub. Date: Feb. 12, 2004

(54) Heart monitoring device

(76) Inventor: Samuel Leven, Loxahatchee Groves, FL (US)

Correspondence Address: AKERMAN SENTERFITT, P.O. BOX 3188, WEST PALM BEACH, FL, 33402-3188, US

(21) Appl. No.: 10/459,880

(22) Filed: Jun. 12, 2003

Related U.S. Application Data
(60) Provisional application No. 60/388,598, filed on Jun. 12, 2002.

(51) Int. Cl. G06F 17/60

(52) U.S. Cl. 705/2

(57) ABSTRACT

A wearable patient health monitoring device includes a plurality of sensors configured to monitor health conditions, a data storage communicably coupled to the sensors for recording monitored health conditions as data, a transceiver communicably coupled to the sensors for wireless communications configured for transmitting and receiving data, and an element for securing said monitoring device to the body. A patient health monitoring system is provided that includes a monitoring device, at least one health professional computing device communicably and at least one third-party computing device, both coupled to the monitoring device via a communications network. A method for monitoring health conditions of a patient includes establishing an individualize patient profile having a normal range of health conditions, sensing patient health conditions, comparing detected health conditions to patient profile, and notifying a health professional when the detected health conditions are outside of the established normal range.

### CROSS REFERENCE TO RELATED APPLICATION

Under 35 USC §119(e), this application claims the benefit of U.S. Provisional Application No. 60/388,598 entitled Health Monitoring Device, filed on Jun. 12, 2002, the entirety of which is now incorporated herein by reference.

### BACKGROUND OF THE INVENTION

1. Technical Field

This invention relates in general to a medical device, and in particular to a wearable health monitoring device.

2. Description of the Related Art

Several attempts have been made to develop an apparatus that provides efficient and reliable health monitoring capabilities. For instance, a number of inventions in the prior art have incorporated the use of devices to monitor medical conditions of bodily organs, such as the heart. Specifically, in U.S. Pat. Pub. No. 2002/0016719 to Nemeth et al. (“Nemeth”), a medical device is disclosed which includes a wireless communication device to receive medical data from a monitor borne by an ambulatory patient and wirelessly transmits at least some of the medical data to a computer network. Nevertheless, the device disclosed in Nemeth fails to provide immediate and individualized health monitoring to a user.

Other health monitoring devices of the prior art fail to combine real-time monitoring, real-time evaluation of the conditions being monitored, administering of real-time health advice, and real-time medication delivery. Thus, while other health monitoring devices can provide portions of a patient's health care needs, a comprehensive health program needs to react immediately the changes in patient health. Moreover, a comprehensive health program can also recognize changes in a patient that may indicate the likelihood of future health problems. Such recognition can allow the patient to advert serious health conditions due to preemptive medical steps.

Additionally, many health monitoring devices are not suitable for monitoring the ambulatory patient in a real world environment. Some monitoring devices require bulky and cumbersome wires while others fail to appropriately and comprehensively monitor the ambulatory patient.

While some health care monitoring devices can contact others in the event of a medical emergency, other individuals may also need to be contacted. For instance, a person having a pace maker or any sort of serious heart ailment requiring medical supervision may need to have constant monitoring of his vital signs to provide instant notice to healthcare officials of any impending threat of heart failure. In addition to notifying the health care officials, other individuals, such as family members or coworkers, may currently remain un-contacted.

Upon receipt of a notification that one's vital signs are abnormal, many users of health monitoring devices must orally ingest medication. If medication is not taken at the appropriate time, a patient can suffer from sudden cardiac arrest, heart failure or other form of organ breakdown. The use of health monitoring devices in combination with the task of taking considerable amounts of medication can be inconvenient and expensive.

### SUMMARY OF INVENTION

The present invention concerns a wearable patient health monitoring device including a plurality of sensors configured to monitor health conditions, a data storage communicably coupled to the sensors for recording monitored health conditions as data, and a transceiver communicably coupled to the sensors for wireless communications configured for transmitting and receiving data. The sensors can include a sensor to monitor heart rate, a sensor to monitor heart murmurs, a sensor to monitor heart intensity, a sensor to monitor lung noise, a sensor to monitor respiration rate, a sensor to monitor for occlusion, a sensor to monitor adrenal level, a sensor to monitor acetycholine level, a sensor to monitor temperature, and a sensor to monitor sodium levels. The monitoring device can also include a user actuator for signaling the transceiver to contact at least one of an emergency services, a health care professional, and a processing device.

In one arrangement, the monitoring device can also include a visual power source indicator. The transceiver can be configured to detect available communication links. The monitoring device can also include a viewing screen for displaying at least one of data from the sensors, data received by the transmitter, and monitor device diagnostic information. The monitoring device also can include a processor operatively connected to the sensors. The processor can be programmed with an individualized patient profile having ranges of normal health conditions, wherein the processor compares detected health conditions to the range of normal health conditions.

In another arrangement, the monitoring device can include a medication delivery structure operatively connected to the processor, where the processor signals the medication delivery structure to deliver medication when health conditions outside of the range of normal health conditions are detected by the sensors. The medication delivery structure is at least one of a dermal patch, a medication port, and a medication pump. The processor can be operatively connected to the transceiver, and the processor can signal the medication delivery structure to deliver medication upon receiving a medication delivery signal from a health professional.

The present invention also provides a patient health monitoring system including a wearable patient health monitoring device having a plurality of sensors configured to monitor health conditions, a data storage for recording monitored health conditions as data, and a transceiver for wireless communications. The system also includes at least one health professional computing device communicably coupled to the monitoring device via a communications network and at least one third party computing device communicably coupled to the monitoring device via a communications network. The system can also include a patient computing device communicably coupled to the monitoring device and communicably coupled to the health professional computing device and the third party computing device via at least one of a wired communications network and a wireless communications network. The patient computing device can be configured to play audible messages.

In one arrangement, the system can include a monitoring device having a processor operatively connected to the sensors where the processor can be programmed with an individualized patient profile. The profile can have ranges of normal health conditions and the processor can compare detected health conditions to the range of normal health conditions. The monitoring device can signal at least one of the patient computing device, the health professional computing device, and the third party computing device when health conditions detected by sensors fall outside of the established normal health conditions. The monitoring device can contact at least one of the health professional computing device and the third party computing device based on data from the monitoring device.

Further the present invention provides a method for monitoring the health conditions of a patient. The method includes establishing an individualized patient profile having normal ranges of health conditions, detecting patient health conditions, comparing detected health conditions to a patient profile, and notifying a health professional when the detected health conditions are outside of the established normal range. The method can also include signaling at least one of a personal computing device, a third party computing device, and a health professional computing device when the detected health conditions are outside of the established normal range.

In one arrangement, the method can include storing at least one prerecorded message and playing at least one prerecorded message. The method can also include receiving medical advice from at least one of the health professional and a third party and delivering medication when the detected health conditions are outside of the established normal range.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 is a schematic diagram illustrating a health monitoring device in accordance with the inventive arrangements disclosed herein.

FIG. 2 is a schematic diagram illustrating the collection and transfer of data via a health monitoring system in accordance with the inventive arrangements disclosed herein.

FIG. 3 is method for monitoring the health conditions of patient in accordance with inventive arrangements disclosed herein.

### DETAILED DESCRIPTION OF THE INVENTION

The invention disclosed herein provides a wearable health monitoring device, system, and method of using the same. Importantly, the device can be used by an ambulatory patient in a real world environment. Specifically, the device can monitor and detect a myriad of health conditions. In accordance with the present invention, health conditions can relate to any bodily condition and substance level that is indicative of the health of an individual. Additionally, a patient health monitoring system allows a user to monitor an individual's health conditions by detecting, storing, analyzing and reporting the health conditions. Furthermore, the device and system can contact the appropriate party at the occurrence of a particular health related event and can provide a real-time medical history to a health professional. Notably, a heath care provider, such as a doctor, can also be provided with access to stored data to facilitate continuous monitoring of a user's health.

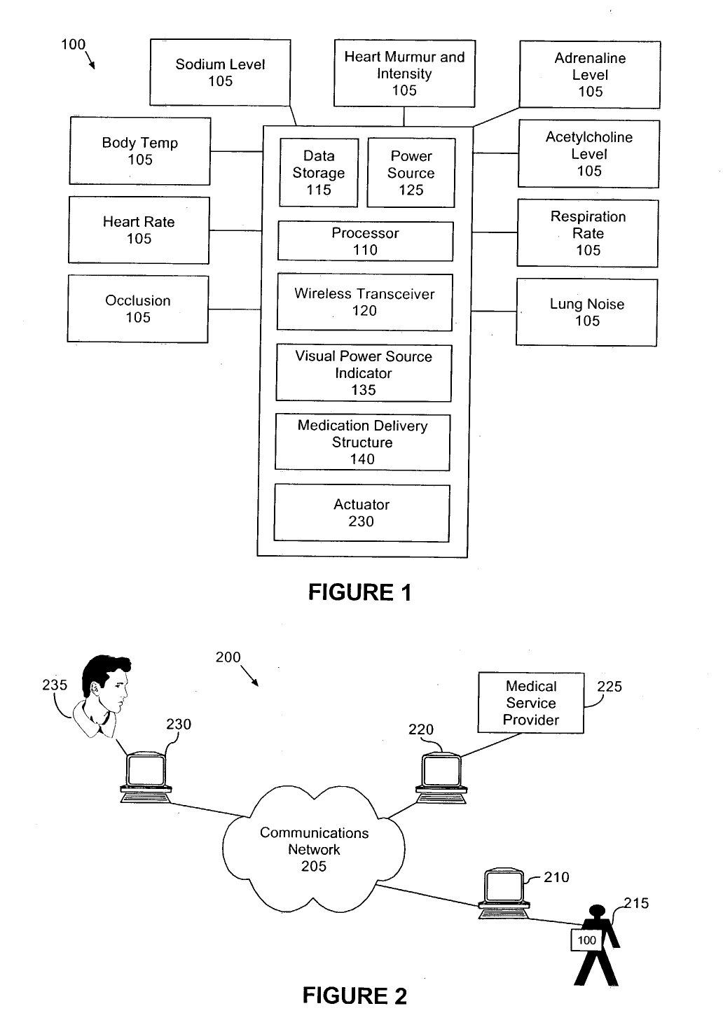

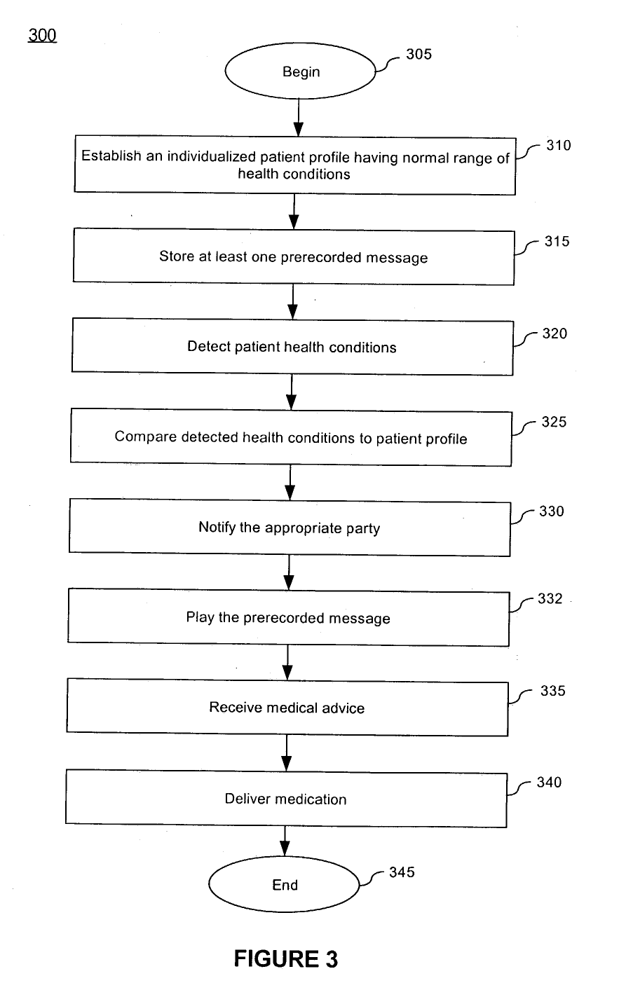

FIG. 1 is a schematic diagram illustrating an exemplary health monitoring device 100 in accordance with the inventive arrangements disclosed herein. As shown in FIG. 1, a health monitoring device 100 can include a wearable health monitor having a plurality of sensors 105. The plurality of sensors 105 can be utilized to monitor various health conditions. The health monitor 100 can include particular sensors 105 for monitoring specific health conditions. For instance, a non-exhaustive list of the particularized sensors 105 that can be provided include a sensor 105 to monitor heart rate, a sensor 105 to monitor heart murmurs, a sensor 105 to monitor heart intensity, a sensor 105 to monitor lung noise, a sensor 105 to monitor respiration rate, a sensor 105 to monitor for occlusion, a sensor 105 to monitor adrenal level, a sensor 105 to monitor acetycholine level, a sensor 105 to monitor temperature, and a sensor 105 to monitor sodium levels. Nevertheless, other sensors 105 can also be added to measure additional health conditions. Importantly, the sensors 105 provided by the health monitoring device 100 can be selected to correspond to the particular needs of a patient to provide the patient with comprehensive and customized health care.

The health monitoring device 100 can also include a data storage 115 for recording monitored health conditions, and a wireless transmitter 120. The data storage 115 can include RAM, ROM, flash based memory, a hard drive, and the like. Advantageously, the data storage 115 can include non-volatile memory that will preserve health records in the unlikely event of a power outage. Furthermore, the data storage 115 can also be removable to allow access to the data in the event of a power outage. The health monitor 100 can also include a transceiver 120 for permitting wireless communication over suitable wireless communication links in a manner that is well known in the industry.

A health monitoring device 100 can also include a power source 125. The power source 125 enables the health monitoring device to operate for extended periods of time without the need for any maintenance. A power source can include a lithium battery or other rechargeable power supply.

Further, the health monitoring device 100 also can include a visual power source indicator 135 to operate as a signaling device to indicate power levels. For instance, the visual indicator 135 can include a red light on the surface of the device 100 to indicate low power levels. Regardless, the monitoring device 100 can be charged using a conventional electrical adapter and/or cradle unit. Notably, the cradle unit can provide a wired link for transmitting and receiving data.

Referring to FIG. 2, the health monitoring device 100 can be used in conjunction with a health monitoring system 200. The health monitoring system 200 includes a health monitoring device 100, a wired or wireless communications network 205, one or more health professional computing devices 220, and one or more third party computing devices 230. Additionally, the system 200 can include a patient computing device 210. The health professional computing devices 220, the one or more third party computing devices 230, and the patient computing device 210 can all be in communication with the health monitor 100 and the each other via the communications network 205. The communications network 205, can include, for example, the Internet, the Public Switched Telephone Network (PSTN), Local Area Networks (LAN), Wide Area Networks (WAN), and the like. Additionally, the wireless communication network 205 can include an suitable wireless communication standard, such as Wi-Fi, 802.11a, 802.11b, 802.11g, and the like.

In one embodiment, data stored in the data storage 115 can be transferred to the patient's computing device 210. Once the data has been transferred to the patient computing device 210, the patient can use software to manipulate, analyze, and view the data. Additionally, the one or more health professional computing devices 220 and the one or more third party computing devices 230 can access the data on the patient computing device via the communications network 205 for further manipulation, analyzing, and viewing. Nevertheless, the inventive arrangements are not so limited.

The monitoring device 100 can communicate with the health professional computing devices 220 and third party computing devices 230 in a variety of configurations. While the monitoring device 100 can directly communicate with the health professional computing devices 220, third party computing devices 230, and the patient computing device 210 over a wireless communications link, i.e. using a cellular communication link or the like, the monitoring device 100 also can communicate indirectly. For instance, the monitoring device 100 can wirelessly communicate to the patient computing device 210 using a short range communication standard, such as Bluetooth or one of the 802.11 family of wireless communication protocols. The patient computing device 210 can then initiate a communication in the form of an electronic mail, text message, and the like. The computing devices further can communicate voice and/or sound messages using a real time voice over Internet Protocol to a remotely located computer. Relaying communications to distant computing devices over the communications network, such as the Internet, can allow for remotely located people to still receive comprehensive medical treatment. In any case, the patient computing device 210 can send a fax or initiate a standard telephone call.

The health professional computing devices 220 and the third party computing devices 230 can also directly communicate with the monitoring device over a wireless communications network 205. Thus, data in the data storage 115 that has not been transferred to the patient computing device 210 can be access directly from the monitoring device 100. Such accessibility may be life saving if vital data has not yet been transferred to the patient computing device 210. Additionally, communication network 205 can allow data to be accessed via a Web site through a visual and/or audio (voice) browser. Data received from third parties also can be downloaded and/or accessed from the user's computer system 210 and/or the health monitoring device 100. Additionally, collected data can be transferred freely from a third party computer system 230 and a doctor's computer system 220 for further detailed analysis as illustrated in FIG. 2.

In operation, a health monitoring device 100 can be strapped to a user's chest, worn around the neck, or generally secured to the body of the user in any suitable fashion. Preferably, the health monitoring device can be unobtrusive and will not interfere with the daily activities of the user. Additionally, the health monitor device 100 can be constructed of a durable material able to withstand daily environmental stress.

As illustrated in FIG. 2, the health professional computing devices 220, the third party computing devices 230, and the patient computing device 210 can include a conventional personal computer equipped with the suitable software. The patient computing device 210 can be utilized to store data continuously until the monitoring device 100 fails, or until the remaining battery power is depleted to a predetermined level, in which case the data can be retrieved manually. Also, depending upon user preference and/or a health care professional's instructions, data can be transmitted continuously in real time, at predetermined intervals, or responsive to a user 215 request. For example, the monitoring device 100 can transmit data to the patient computing device 210, the health professional computing devices 220, the third party computing devices 230 in real time with the detection of a condition.

In another embodiment, the monitoring device 100 can include an actuator 130 for signaling the transceiver 120 to contact emergency services (i.e. 911) and a health care professional. For example, the user 215 experiencing any noticeable changes in pulse rate or other symptoms of possible health problems, can instantly transmit data to a doctor 235 by engaging the actuator 130 located on the monitoring device 100. The actuator can also be used to transfer the data on the monitoring device 100 to the appropriate computing device. Thus the actuator 130 can be used as a panic button, which can provide the latest monitoring data available as well as initiate 911 calls or other calls to preprogrammed numbers when engaged. For example, the monitoring device 100 can include cellular communications and audio capability to call or cause the patient computing device 210 to call, and play prerecorded messages in the event the user is incapacitated. Similarly, a user 215 can transmit data to the doctor 225 in intervals providing the doctor 225 the ability to monitor the user's 215 corresponding health conditions without the user 215 being located in the doctor's 225 office.

One aspect of the present invention can automatically detect an operative wireless communications link. In the event such a link is detected and a connection is made, the invention can transmit the data to a remotely located computer system, which is accessible through the wireless communications link. The data can be transmitted with a unique identifier corresponding to the user's 215 identity. Once the data is transmitted, the data can be processed, whether in the home of the user 215 on the patient computing device 210 or on a remotely located computer, such as computing devices 220 and 230, by software configured to detect particular health conditions through analysis of the collected data. If necessary, the software can send electronic alerts to the user's doctor 225. The data also can be processed in a server communicatively linked to the computer communications network and made available through a Web site for user, doctor, and/or third party review. Advantageously, the invention allows data to be collected over a period of weeks thereby facilitating the early detection of deteriorating health conditions through the analysis of health conditions collected over an extended period of time.

In one aspect of the invention, the doctor 225 can be prompted or notified of any changes in health conditions. For example, the data collected can be provided to a user's doctor 225 to alert the doctor 225. Subsequently, the doctor 225 can prepare to proceed with the necessary steps to prevent and treat any health conditions. For instance, if a user 215 has an increase in heartbeat, the health monitoring device 100 can detect these changes and provide important data to the doctor 225. Upon receipt of such information, the doctor 225 can attempt to administer preventative medication and develop alternative medical treatment as may be determined and recommended by a physician or health service. For example, physicians and/or third party medical services can make medical treatment recommendations which can be transmitted to the patient computing device 210 or to the health monitor device 100.

Additionally, although not shown, the health monitor 100 can include a display screen for viewing data collected by the monitor's sensors, received information from the computer communications network 205, instructions from the doctor 225, and/or other unit diagnostic information. The data relating to the user's 215 health conditions also can be utilized to prepare an early diagnosis in the instance of an emergency situation before a doctor 225 has actually physical examined the user.

Similarly, the invention disclosed herein can be used to transfer data concerning the user's 215 vital signs to a third party 235. As illustrated in FIG. 2, the data can be transferred to a third party, such as a family member or the like, to provide the designated third party 235 with important information regarding the user's 225 heart condition. For instance, a third party 235, such as a spouse, can utilize the computer system 230 to upload data and maintain a constant source of information regarding a particular user's 215 heart condition during specific intervals or other selected time periods.

In an alternative embodiment of the present invention, data from the user's computer system 210 and computer communications network 205 can be equipped with a password to provide security measures. For example, the user's doctor 225 or other third party 235 can be equipped with a password to ensure that the personal information of the user 215 can only be accessed by these designated individuals. Accordingly, any individual attempting to access the computer communication network 205 without an authorization password to verify that the user 225 granted access to available storage data will be denied.

The monitoring device 100 can also include processor 110. The processor 110 can be communicably coupled to the sensors 105 for the transfer of data from the sensors to the processor. The processor 110 can be programmed with an individualized patient profile having a range of normal health conditions. The patient profile can include ranges for the user's normal range of heart beat, murmurs, adrenaline levels, and other health conditions. With an established patient profile, the processor 110 can compare detected health conditions to the normal ranges for the individual. If a particular detection falls outside of the normal range, the monitoring device 100 can contact the appropriate computing device via email, instant message, text message, fax, and the like.

In another embodiment, the monitoring device 100 can include a medication delivery structure 140, such as a dermal patch, medication port, and a medication pump. The medication delivery structure 140 can be communicably coupled to the processor 110 and the transceiver 120. Since, the medication delivery structure 140 is communicably connected to the processor 110, the monitoring device 100 can provide automated health care. When the processor determines that a detected health condition is outside of the normal range of values established in the patient profile, the processor can signal the medication delivery structure 140 to deliver the appropriate medicine. Such an embodiment provides the advantages of regulating health conditions. For example, the monitoring device can be used to regulate a women's hormone levels based upon ovulation cycles.

In another embodiment, the medication delivery structure 140 can be communicably coupled to the transceiver 140. Thus, a doctor 225 can view data sent by the monitoring device 100, analyze the data, and send medication instructions to the monitoring device 100. In response, the processor can interpret the instructions and signal the medication delivery structure 140 to deliver the appropriate medicine. Such an embodiment can provide medicine in the crucial emergency stages of the first minutes of a heart attack.

The wireless connectivity of the present invention can support additional emergency functions. For example, healthcare facilities such as emergency rooms and the like, can be equipped with wireless communication equipment for communicating with the health monitor device. Thus, if a user is brought into such a facility, the health monitor device 100 can detect a wireless network connection and upload any collected data to the healthcare facility computer system so that the user may be readily diagnosed. Similarly, when traveling, various establishments can be equipped with wireless communication equipment allowing the health monitor device 100 to automatically detect a network connection and upload data that can be sent to any one of a variety of network addresses including, but not limited to, the user's computer system 210 and third party computer systems 220 and 230. Thus, data can be archived and/or analyzed without the user having to be in close proximity to the user's home computer 210.

The system 200 can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

Additionally, a method 300 for monitoring a patient is provided. The method 300 can use the monitoring device 100 and health monitoring system 200 discussed above, however, the invention is not so limited. The method 300 can be practiced without a device or with any suitable device.

Method 300 can begin at step 305. At step 310, a patient profile can be established. The patient profile can include a normal range of health conditions for the particular patient. For instance, the patient profile can include the range of normal resting heart rates for the particular patient. Other relevant information, such as weight, height, and medical history can also be included in the patient profile as such information can be beneficial to medical diagnosis.

At step 315, one or more prerecorded messages can be stored. The prerecorded messages can include messages related to the health conditions of the individuals. An example of one such a message can include a message indicating recent surgery, allergies, or other pertinent medical information. Such a message may provide crucial information to a medical provider that is not readily available. Additionally, the message can also be a general message to a family or friend. The message could simply be a reminder to walk the patient's dogs if the patient is unconscious in the hospital.

At step 320, patient health conditions can be detected. Step 320 can involve routine measurements, such as detecting body temperature, and can also include complex measurements, such as detecting acetycholine levels. As discussed above, a health monitoring device can be used to detect the patient conditions; nevertheless, multiple instruments, devices, and sensors, can be employed to detect a patient's health conditions.

Turning to step 325, the health conditions that were detected in step 320 can be compared to the patient profile. The comparison can include a simple numerical evaluation of whether a detected condition falls within the normal range of values for that particular patient. Nevertheless, the invention is not so limited. The comparison can also compare a detected condition to a multitude of information within the patient profile. For instance, it may be beneficial to compare a rise in heart rate to multiple hormone levels. In some circumstances, a rise in heart rate can be considered normal, and therefore, should not always be a cause for concern when detected conditions fall outside of normal ranges.

In step 330, the appropriate party can be notified when the detected conditions are outside the normal range. The appropriate party can include a health care professional, or a computing device, such as a personal computing device or a computing device of a health care provider or third party. Additionally, the notification can be an indirect notification where multiple devices relay the notification over a communications network, such as the Internet. Notifying the appropriate party when a detected condition is outside of a predetermined range can allow for immediate medical attention. Furthermore, a medical emergency may be averted in method 300 because detected conditions that may indicate an even worse health condition can be used to trigger the notification of the appropriate party. With early detection, appropriate measures can be taken to avoid an emergency situation.

Other parties besides a health care professional can also be notified. For instance, a detected condition may trigger signaling a family member in a situation where there is no immediate medical emergency. For instance, if vitamin C levels are detected to be too low, a relative may want to be notified. In such an event, a relative, instead of a costly doctor, can respond to the notification and remind the patient to take a multi-vitamin.

In step 332, one or more recorded messages can be played. The message can be played with a conventional speaker, but the message can also include audio and video to be played on a viewing screen. The message can be played to the same party that was signaled in step 330; however, the invention is not limited in this regard. The message can be played to any appropriate party. The contents of the message can include instructions to a relative, notification for the health care professional of any relevant health conditions, and any other appropriate message including recently and stored measured health conditions.

In step 335, medical advice can be received. Typically, the medical advice can relate to the detected conditions. For instance, if detected conditions are compared to normal ranges, and the detected conditions indicate an imminent heart attack, advice can be received regarding which medicine to take. Also typically, the medical advice can be sent from a health care professional; however, other parties, such as a nutritionist, can also send the medical advice that is received. The medical advice can be received in the form of a phone call, a text message, a digital signal, or any other suitable means of communication whether received by the device, the patient computing device, the telephone, fax, and the like.

In step 340, medication can be delivered to the patient. Typically, medication can be delivered when detected conditions are outside of the patient's normal range. Thus, the delivery of medication to the patient can be in direct response to the detected conditions. The instructions to medicate can be included in the medical advice that is received in step 335 which can include not only textual, audio, video instructions and comments, but also instructions to increase dosage, decrease dosage, and delivery a one-time dosage. Medication can be delivered in the appropriate manner, such as orally, intravenously, subcutaneously and via any appropriate medication delivery structure. The method can end at step 345 or can return to the beginning step 305.

Aspects of the present invention can also can be embedded in a computer program product, which comprises all the features enabling the implementation of the system described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A wearable patient health monitoring device comprising:
a plurality of sensors configured to monitor health conditions;
a data storage communicably coupled to said sensors for recording monitored health conditions as data; and
a transceiver communicably coupled to said sensors for wireless communications configured for transmitting and receiving data.

2. The monitoring device according to claim 1, wherein said sensors include a sensor to monitor heart rate, a sensor to monitor heart murmurs, a sensor to monitor heart intensity, a sensor to monitor lung noise, a sensor to monitor respiration rate, a sensor to monitor for occlusion, a sensor to monitor adrenal level, a sensor to monitor acetycholine level, a sensor to monitor temperature, and a sensor to monitor sodium levels.

3. The monitoring device according to claim 1, further comprising a user actuator for signaling the transceiver to contact at least one of an emergency services, a health care professional, and a processing device.

4. The monitoring device according to claim 1, further comprising a visual power source indicator.

5. The monitoring device according to claim 1, wherein the transceiver is configured to detect available communication links.

6. The monitoring device according to claim 1, further comprising a viewing screen for displaying at least one of data from said sensors, data received by said transmitter, and monitor device diagnostic information.

7. The monitoring device according to claim 1, further comprising a processor operatively connected to said sensors, said processor programmed with an individualized patient profile having ranges of normal health conditions, wherein said processor compares detected health conditions to said range of normal health conditions.

8. The monitoring device according to claim 7, further comprising a medication delivery structure operatively connected to said processor, wherein said processor signals said medication delivery structure to deliver medication when health conditions outside of said range of normal health conditions are detected by said sensors.

9. The monitoring device according to claim 8, wherein the medication delivery structure is at least one of a dermal patch, a medication port, and a medication pump.

10. The monitoring device according to claim 7, wherein said processor is operatively connected to said transceiver, said processor signals said medication delivery structure to deliver medication upon receiving a medication delivery signal from a health professional.

11. The monitoring device according to claim 10, wherein the medication delivery structure is at least one of a dermal patch, a medication port, and a medication pump.

12. A patient health monitoring system comprising:
a wearable patient health monitoring device having a plurality of sensors configured to monitor health conditions, a data storage for recording monitored health conditions as data, and a transceiver for wireless communications;
at least one health professional computing device communicably coupled to said monitoring device via a communications network;
at least one third party computing device communicably coupled to said monitoring device via a communications network.

13. The monitoring system according to claim 12, further comprising a patient computing device communicably coupled to said monitoring device and communicably coupled to said health professional computing device and said third party computing device via at least one of a wired communications network and a wireless communications network.

14. The monitoring system according to claim 12, wherein said patient computing device is configured to play audible messages.

15. The monitoring system according to claim 14, wherein said monitoring device further includes a processor operatively connected to said sensors, said processor programmed with an individualized patient profile having ranges of normal health conditions, wherein said processor compares detected health conditions to said range of normal health conditions.

16. The monitoring system according to claim 15, wherein said monitoring device signals at least one of said patient computing device, said health professional computing device, and said third party computing device when detected health conditions are health conditions outside of said normal health conditions are detected by said sensors.

17. The monitoring system according to claim 12, wherein said monitoring device contacts at least one of said health professional computing device and said third party computing device based on data from said monitoring device.

18. A method for monitoring the health conditions of a patient, comprising the steps of:
establishing an individualized patient profile having normal ranges of health conditions;
detecting patient health conditions;
comparing detected health conditions to a patient profile; and
notifying a health professional when the detected health conditions are outside of the established normal range.

19. The method according to claim 18, further comprising the step of signaling at least one of a personal computing device, a third party computing device, and health professional computing device when the detected health conditions are outside of the established normal range.

20. The method according to claim 18, further comprising the step of:
storing at least one prerecorded message; and
playing at least one prerecorded message.

21. The method according to claim 18, further comprising the step of receiving medical advice from at least one of the health professional and a third party.

22. The method according to claim 18, further comprising the step of delivering medication when the detected health conditions are outside of the established normal range.
